(19) United States
(12) Patent Application Publication
(10) Pub. No.: US 2020/0156232 A1
(43) Pub. Date: May 21, 2020

(54) SPEED SWITCHING STRUCTURE FOR AN ELECTRIC AND PNEUMATIC TOOL

(71) Applicant: ACT QUALITY INDUSTRIAL CO., LTD., Taichung City (TW)

(72) Inventor: Chun-Hsiao Huang, TAICHUNG CITY (TW)

(21) Appl. No.: 16/240,779

(22) Filed: Jan. 6, 2019

(30) Foreign Application Priority Data
Nov. 15, 2018 (CN) 201811359983.2

(51) Int. Cl. B25F 5/00

(52) U.S. Cl. CPC B25F 5/001; B25F 5/02

(57) ABSTRACT

A speed switching structure for an electric and pneumatic tool has a head portion disposed at a front end of the electric and pneumatic tool. The head portion is jacketed with a control ring and a sliding sleeve, and the control ring is connected to a gear ring of a shifting assembly disposed in the head portion. The shifting assembly has a first epicyclic frame mounted in the gear ring and a second epicyclic frame and a securing gear ring mounted in the head portion and behind the gear ring, and the first epicyclic frame is coupled with a central shaft extending from a front end of the head portion.

### BACKGROUND OF INVENTION

### Field of Invention

The present invention relates to a speed switching structure, and more particularly to a speed switching structure for an electric and pneumatic tool.

### Description of the Related Art

Currently, for conventional electric drills and pneumatic drills, there are two main types of design, one is to provide high speed and low torque at start-up, and the other is high torque with low rotation speed. However, it is difficult to achieve that the same electric and pneumatic tool having both high speed and high torque, and even if the switching is complicated. Therefore, two different types of electric and pneumatic tools will be prepared, as a result, the cost will increase and it will be more troublesome for carrying or storing.

Therefore, it is desirable to provide a speed switching structure for an electric and pneumatic tool to mitigate and/or obviate the aforementioned problems.

### SUMMARY OF THE INVENTION

An objective of present invention is to provide a speed switching structure for an electric and pneumatic tool, which is capable of improving the above-mention problems.

In order to achieve the above mentioned objective, a speed switching structure for an electric and pneumatic tool has a head portion disposed at a front end of the electric and pneumatic tool. The head portion is jacketed with a control ring and a sliding sleeve, and the control ring is connected to a gear ring of a shifting assembly disposed in the head portion. The shifting assembly has a first epicyclic frame mounted in the gear ring and a second epicyclic frame and a securing gear ring mounted in the head portion and behind the gear ring, and the first epicyclic frame is coupled with a central shaft extending from a front end of the head portion.

Other objects, advantages, and novel features of invention will become more apparent from the following detailed description when taken in conjunction with the accompanying drawings.

### BRIEF DESCRIPTION OF DRAWINGS

FIG. 1 is a perspective view of an electric and pneumatic tool of a preferred embodiment according to the present invention.

FIG. 2 is a three-dimensional combination drawing according to the preferred embodiment of the present invention.

FIG. 3 is a perspective exploded view according to the preferred embodiment of the present invention.

FIG. 4 is a plan view of the combination according to the preferred embodiment of the present invention.

FIG. 5 is a status drawing of a high speed mode alone line A-A of FIG. 4 according to the preferred embodiment of the present invention.

FIG. 6 is a movement drawing showing the shifting switching according to the preferred embodiment of the present invention.

FIG. 7 is another movement drawing showing the shifting switching according to the preferred embodiment of the present invention.

FIG. 8 is another movement drawing showing the shifting switching according to the preferred embodiment of the present invention.

FIG. 9 is a status drawing showing the high torque mode according to the preferred embodiment of the present invention.

FIG. 10 is a cross-sectional view taken along line B-B of FIG. 9 according to the preferred embodiment of the present invention.

FIG. 11 is a perspective exploded view of another preferred embodiment according to the present invention.

FIG. 12 is a sectional view showing a combination of another preferred embodiment according to the present invention.

FIG. 13 is a perspective exploded view of another preferred embodiment according to the present invention.

### DETAILED DESCRIPTION OF THE PREFERRED EMBODIMENT

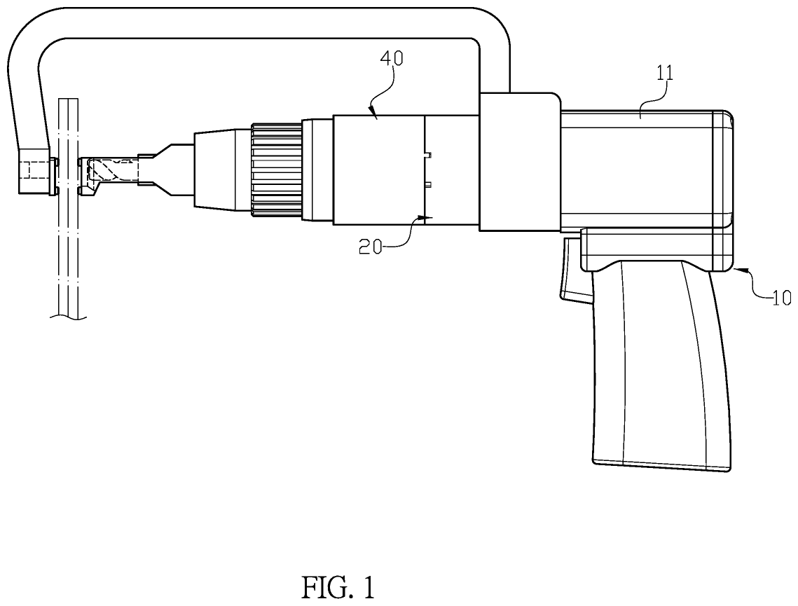

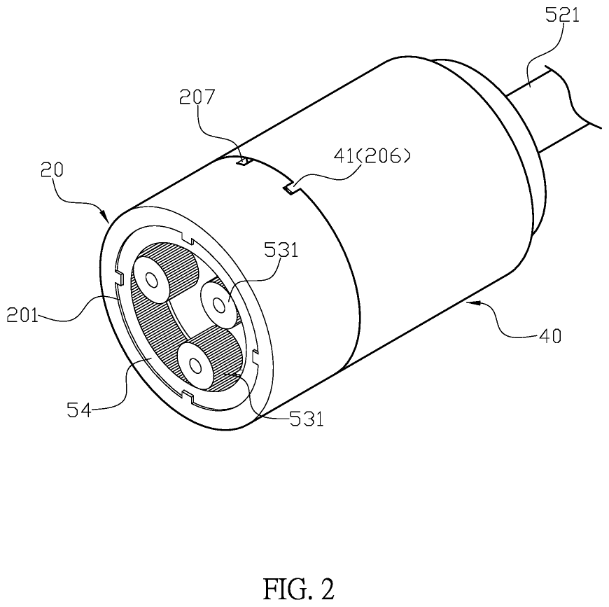

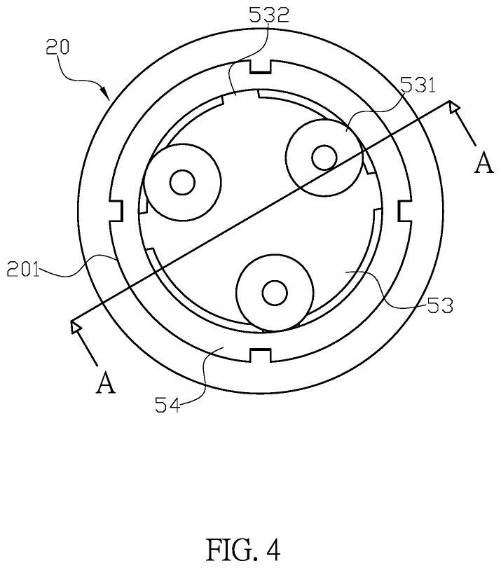

Please refer to FIGS. 1 to 5. A speed switching structure for an electric and pneumatic tool 10 comprises a head portion 20 disposed at a front end of a main body 11 of the electric and pneumatic tool. The head portion 20 is jacketed with a control ring 30 and a sliding sleeve 40, and the control ring 30 is connected to a gear ring 51 of a shifting assembly 50 disposed in the head portion 20. Therefore, by moving the sliding sleeve 40, the control ring 30 drives the gear ring 51 to move along the same direction. The shifting assembly 50 has a first epicyclic frame 52 mounted in the gear ring 51 and a second epicyclic frame 53 and a securing gear ring 54 mounted in the head portion 20 and behind the gear ring 51. The first epicyclic frame 52 is coupled with a central shaft 521 extending from a front end of the head portion 20. The front end and the rear end of the head portion 20 respectively have a first opening 201 and a second opening 202 connected with each other, and the first opening 201 has a first fastening portion 203 at a bottom. The head portion 20 further has a neck portion 204 configured for accepting the control ring 30 and the sliding sleeve 40, such that a rear end of the sliding sleeve 40 pushes against an elastic member 21 disposed on an edge side 205 of the neck portion 205. The edge side 205 of the neck portion 204 further has a first fastening slot 206 and a second fastening slot 207, and the neck portion 204 further has a plurality of long apertures 208 through the first opening 201. The control ring 30 has a plurality of joining pins 31 corresponding to the long apertures 208, and the joining pins 31 extend through the long apertures 208 and both sides of the head portion 20 and engage with the sliding sleeve 40 and the gear ring 51, such that the control ring 30 is able to drive the gear ring 51 via the joining pins 31 along the long apertures 208. An insertion block 41 extends from a rear end of the sliding sleeve 40 and engages with the first fastening slot 206. The sliding sleeve 40 has a plurality of containing channels 42 corresponding to the long apertures 208. When the sliding sleeve 40 is jacketed onto the neck portion 204, the joining pins 31 extend from one end of the control ring 30 and enter into the containing channels 42 such that the sliding sleeve 40, the control ring 30 and the gear ring 51 are connected together via the joining pins 31, and one of the containing channels 42 or the long apertures 208 of the head portion 20 is inclined. The gear ring 51 is jacketed onto the first opening 201 of the head portion 20 and has a second fastening portion 511 engaging the first fastening portion 203. The gear ring 51 further has a third fastening portion 512 at a rear end. The first epicyclic frame 52 has a plurality of first epicyclic gears 522, the first epicyclic frame 52 is inserted into the gear ring 51, the central shaft 521 extending from the second opening 202 and the first epicyclic gears 522 engages with the gear ring 51. The second epicyclic frame 53 has a plurality of second epicyclic gears 531 and a fourth fastening portion 532 and is combined with a sun gear 533c engaging each first epicyclic gear 522. A securing gear ring 54 is mounted at the first opening 201 and coupled with the first epicyclic frame 52 to secure the second epicyclic frame 53 in the first opening 201, and the securing gear ring 54n engages the second epicyclic gear 53 of the second epicyclic frame 531.

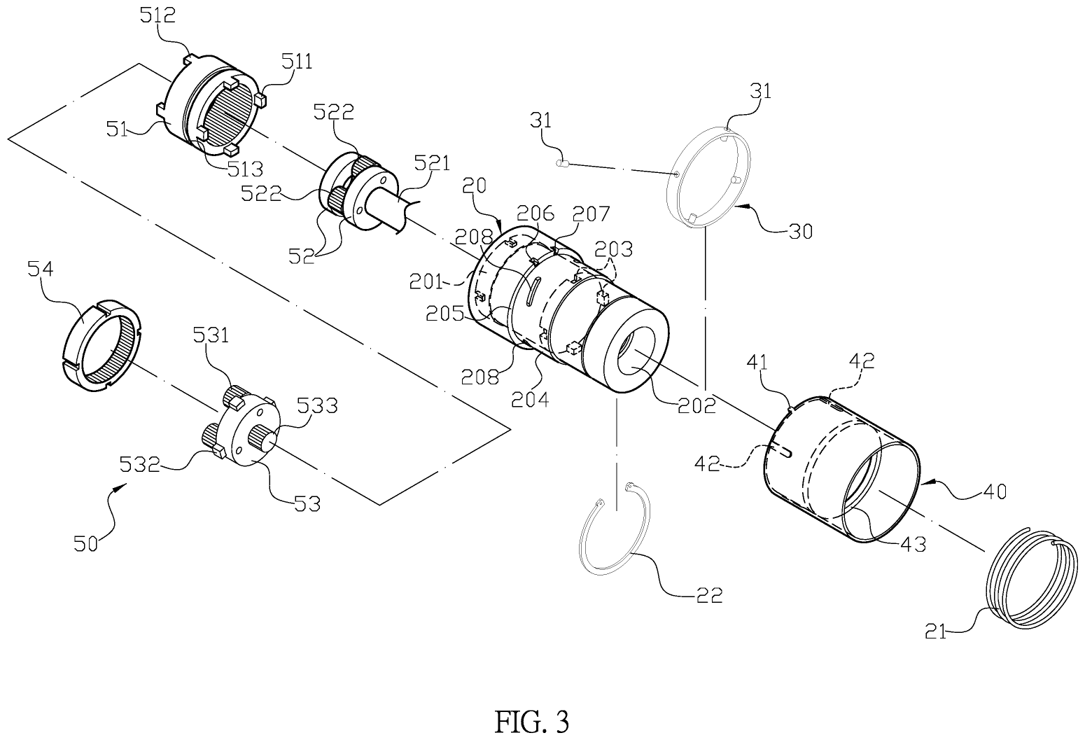

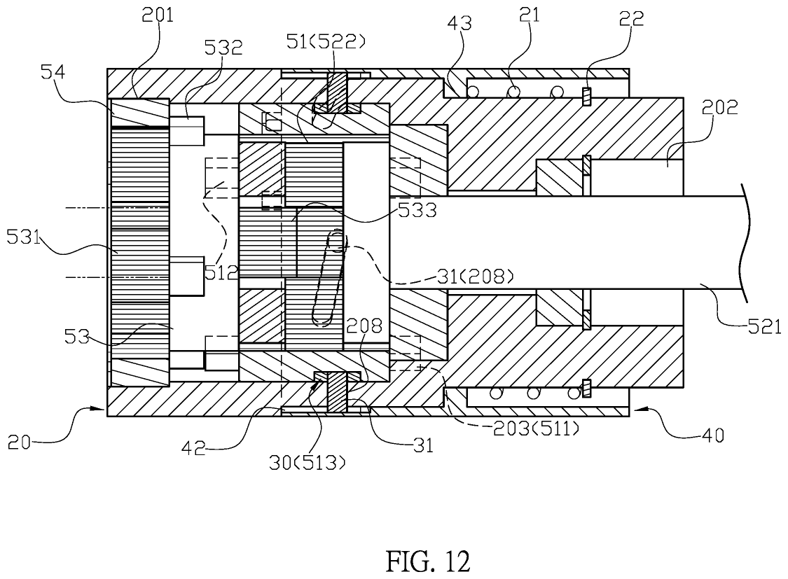

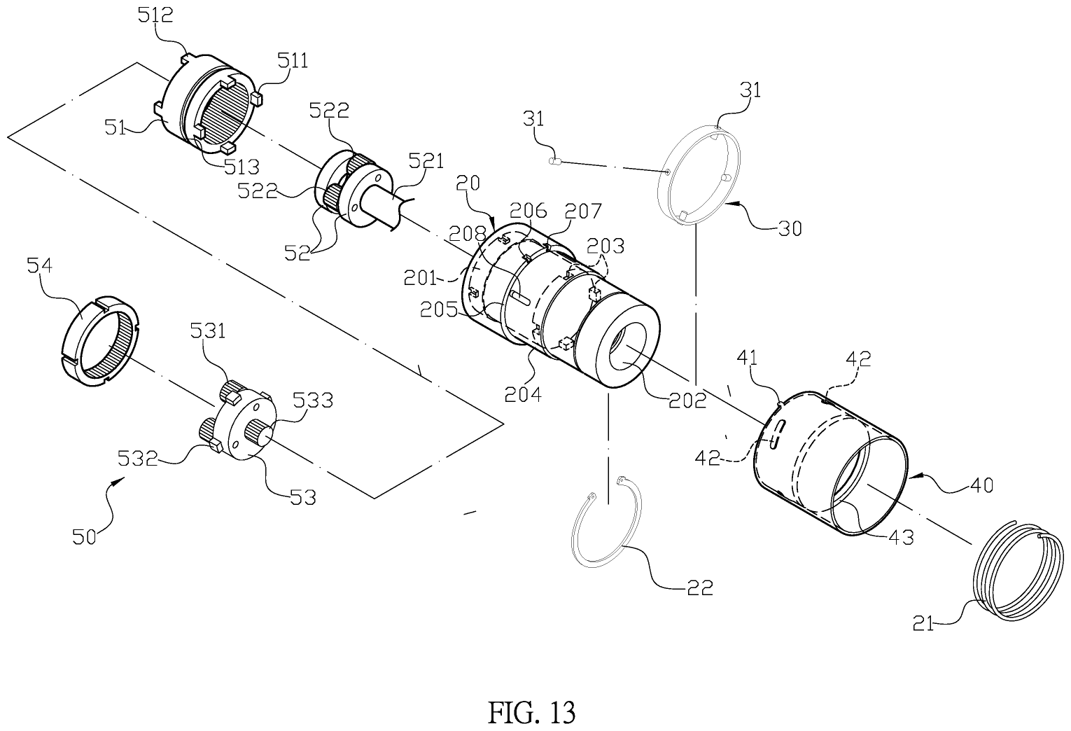

Furthermore, the sliding sleeve 40 further comprises a stepped portion 43, the head portion 20 further has a stopping buckle 22, and when the elastic member 21 is disposed between the sliding sleeve 40 and the head portion 20, the stepped portion 43 and the stopping buckle 22 respectively push against two ends of the elastic member 21. The elastic member 21 is a spring. The long apertures 208 are inclined toward the edge side 205, and the containing channels 42 are disposed at the rear end of the sliding sleeve 40, please refer to FIGS. 3, 5, 6, 7, 8 and 9. The containing channels 42 are inclined toward the insertion block 41, and the long apertures 208 extend forward from the edge side 205, please refer to FIG. 13. The first fastening portion 203 and the second fastening portion 301 are a female and male combination. Moreover, the third fastening portion 512 and the fourth fastening portion 532 are protrusions. The gear ring 51 further comprises a ring slot 513 for accepting the joining pins 31. The control ring 30 is disposed in the ring slot 513, and an ends of the joining pins 31 on the control ring 30 extending from the long apertures 208 into the containing channel 42 of the sliding sleeve 40, please refer to FIGS. 11 and 12. Therefore, the head portion 20 are connected with the gear ring 51 such that the control ring 30 is capable of driving the gear ring 51 due to limited movement of the joining pins 31 along the long apertures 208.

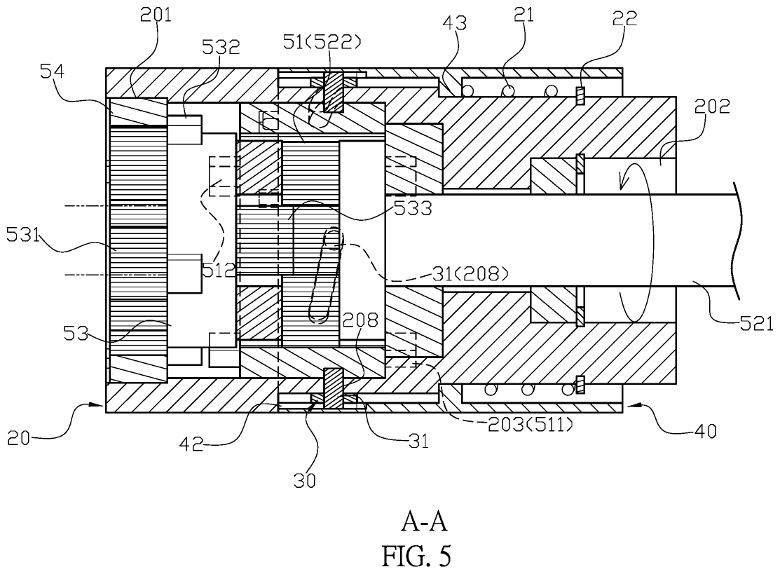

With the above structure, since the insertion block 41 is normally inserted into the first fastening slot 206, the gear ring 51 can be maintained in the front position by the connection of the sliding sleeve 40 and the control ring 30, and the second fastening portion 511 is embedded in the first fastening portion 203 of the head portion 20, as shown in FIG. 5. When the electric and pneumatic tool 10 is activated, the shifting assembly 50 receives the power, the gear ring 51 cannot be rotated by the first epicyclic gear 522, so that only the connection among the first epicyclic gear 522, the sun gear 533, the second epicyclic gear 531 and the securing gear ring 54 of the shifting assembly 50 outputs power in a high-speed and low-torque mode.

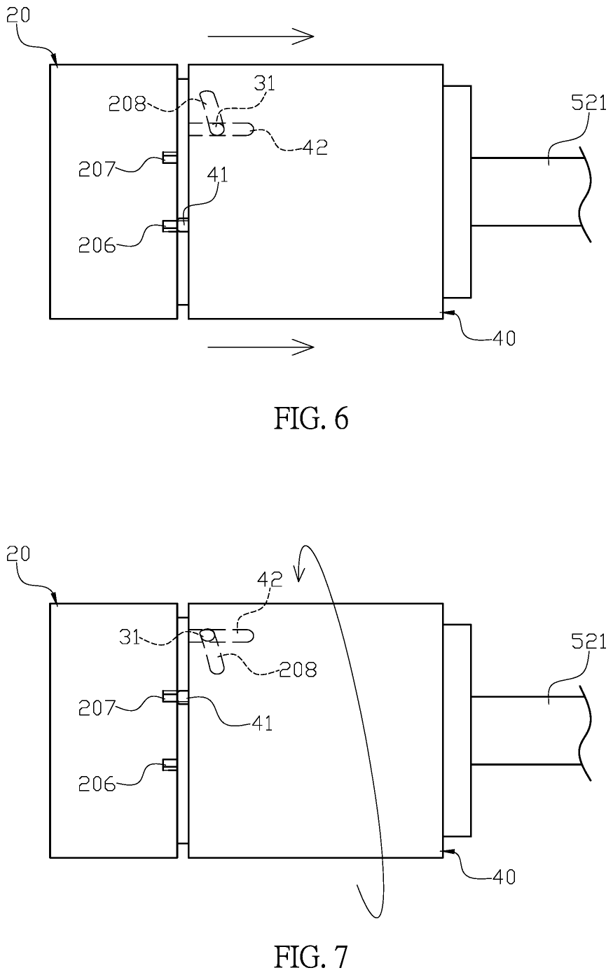

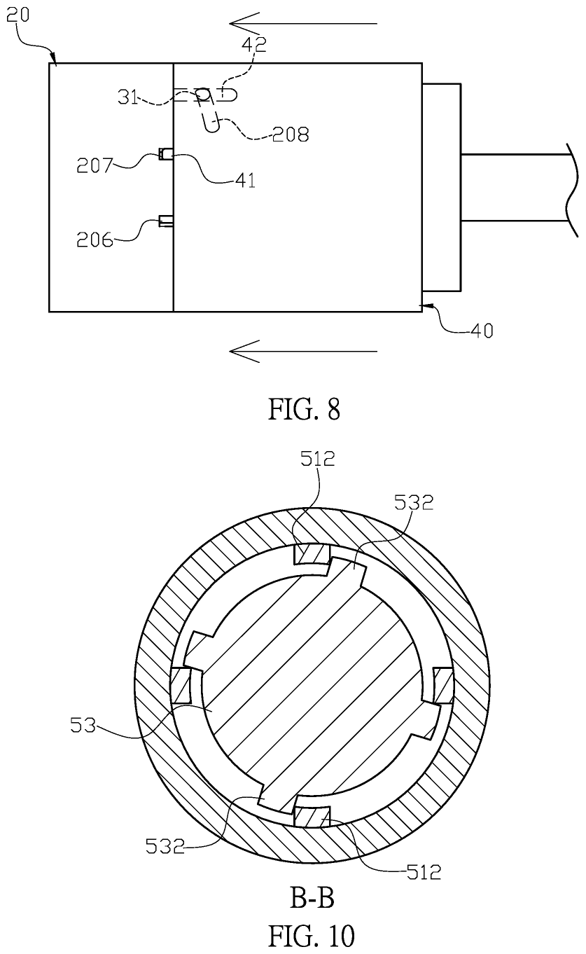

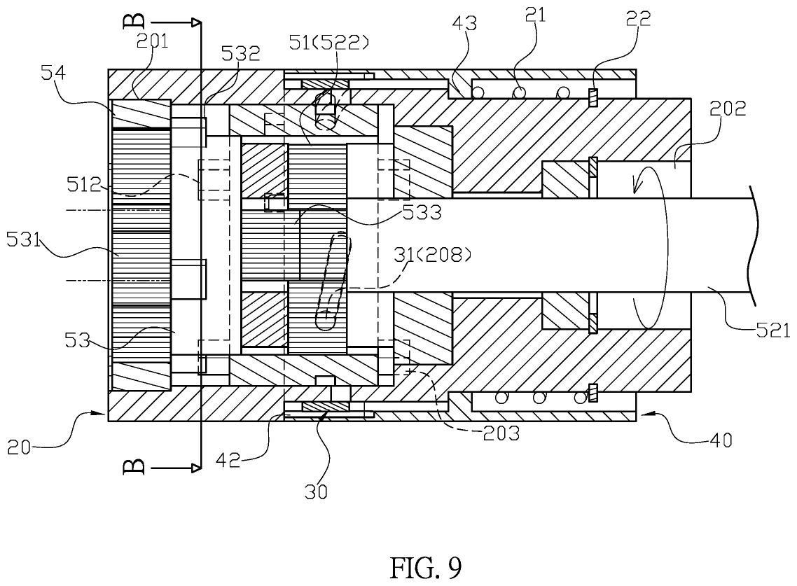

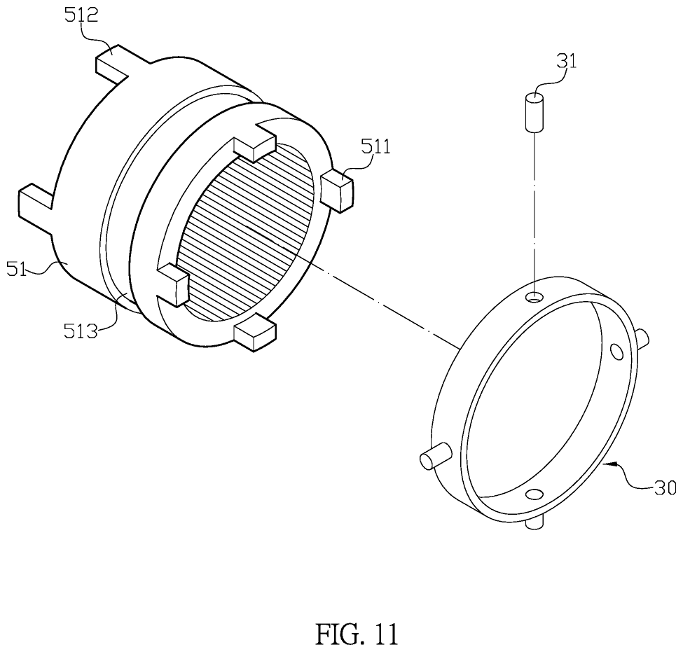

In the process of using high torque and low speed, a forward thrust is applied to the sliding sleeve 40, and the containing channel 42 is provided to allow the joining pin 31 to move which enables the sliding sleeve 40 to smoothly drive the insertion block 41 to disengage the first fastening slot 206, please refer to FIG. 6. Meanwhile, the elastic member 21 is compressed, the sliding sleeve 40 is pushed forward and then uses the containing channel 42 to clamp the joining pin 31 along the long aperture 208, so that the sliding sleeve 40 can drive the control ring 30 and the gear ring 51 to move back via rotation, as shown in FIG. 7. Therefore, the insertion block 41 moves into the second the fastening slot 207, as shown in FIG. 8. Now, the second fastening portion 511 of the gear ring 51 disengages from the first fastening portion 203 of the head portion 20, and the third fastening portion 512 and the fourth fastening portion of the second epicyclic frame 53 are engaged, as shown in FIG. 9 and FIG. 10. Therefore, the gear ring 51 not only is driven by the first epicyclic gear 522 but also produces a boosting effect to the rotation of the second epicyclic frame 53 driven by the first epicyclic gear 522 via the sun gear 533, with the engagement of the third fastening portion 512 and the fourth fastening portion 532 during the rotation process. With the connection of the first epicyclic gear 522, the gear ring 51, the sun gear 533, the second epicyclic frame 53, the second epicyclic gear 531 and the securing gear ring 54 will enable the electric and pneumatic tools 10 to be used in a low-speed and high-torque output mode.

The above-mentioned speed switching structure for an electric and pneumatic tool has the following advantages: the electric and pneumatic tool 10 is equipped with two modes: a high speed and low torque mode and a high torque and low speed mode, and it only needs a simple push and twist for switching speed mode. Therefore, the user only need one electric and pneumatic tool 10 to cope with most of the task, which is affordable and very convenient, and the tool is also easier and faster to operate.

Although the present invention has been explained in relation to its preferred embodiment, it is to be understood that many other possible modifications and variations can be made without departing from the spirit and scope of invention as hereinafter claimed.

What is claimed is:

1. A speed switching structure for an electric and pneumatic tool comprising a head portion disposed at a front end of the electric and pneumatic tool, the head portion jacketed with a control ring and a sliding sleeve, the control ring connected to a gear ring of a shifting assembly disposed in the head portion, the shifting assembly having a first epicyclic frame mounted in the gear ring and a second epicyclic frame and a securing gear ring mounted in the head portion and behind the gear ring, the first epicyclic frame coupled with a central shaft extending from a front end of the head portion, wherein:
the front end and the rear end of the head portion respectively have a first opening and a second opening connected with each other, and the first opening has a first fastening portion at a bottom; the head portion further has a neck portion configured for accepting the sliding sleeve, such that a rear end of the sliding sleeve pushes against an elastic member disposed on an edge side of the neck portion; the edge side of the neck portion further has a first fastening slot and a second fastening slot, and the neck portion further has a plurality of long apertures through the first opening;
the control ring has a plurality of joining pins corresponding to the long apertures, the joining pins extending through the long apertures and both sides of the head portion and engaging the sliding sleeve and the gear ring, such that the control ring is able to drive the gear ring via the joining pins along the long apertures;
an insertion block extends from a rear end of the sliding sleeve and engages with the first fastening slot; the sliding sleeve has a plurality of containing channels corresponding to the long apertures; when the sliding sleeve is jacketed onto the neck portion, the joining pins extend from one end of the head portion and enter into the containing channels such that the sliding sleeve, the control ring and the gear ring are connected together via the joining pins, and one of the containing channels or the long apertures of the head portion is inclined; and
the gear ring is jacketed onto the first opening of the head portion and has a second fastening portion engaging the first fastening portion; the gear ring further has a third fastening portion at a rear end; the first epicyclic frame has a plurality of first epicyclic gears, the first epicyclic frame is inserted into the gear ring, the central shaft extending from the second opening and the first epicyclic gears engages with the gear ring; the second epicyclic frame has a plurality of second epicyclic gears and a fourth fastening portion and is combined with a sun gear engaging each first epicyclic gear; a securing gear ring is mounted at the first opening and coupled with the first epicyclic frame to secure the second epicyclic frame in the first opening, and the securing gear ring engages the second epicyclic gear of the second epicyclic frame.

2. The speed switching structure for an electric and pneumatic tool as claimed in claim 1, wherein the sliding sleeve further comprises a stepped portion, the head portion further has a stopping buckle, and when the elastic member is disposed between the sliding sleeve and the head portion, the stepped portion and the stopping buckle respectively push against two ends of the elastic member.

3. The speed switching structure for an electric and pneumatic tool as claimed in claim 1, wherein the elastic member is a spring.

4. The speed switching structure for an electric and pneumatic tool as claimed in claim 1, wherein the long apertures are inclined toward the edge side, and the containing channels are disposed at the rear end of the sliding sleeve.

5. The speed switching structure for an electric and pneumatic tool as claimed in claim 1, wherein the containing channels are inclined toward the insertion block, and the long apertures extend forward from the edge side.

6. The speed switching structure for an electric and pneumatic tool as claimed in claim 1, wherein the first fastening portion and the second fastening portion are a female and male combination.

7. The speed switching structure for an electric and pneumatic tool as claimed in claim 1, wherein the third fastening portion and the fourth fastening portion are protrusions.

8. The speed switching structure for an electric and pneumatic tool as claimed in claim 1, wherein the control ring is jacketed onto the neck portion of the head portion, and the control ring is disposed between the neck portion and the sliding sleeve, the control ring having the plurality of joining pins corresponding to the long apertures extending from both sides of the head portion, and an ends of the joining pins extending from the long apertures into the head portion are connected with the gear ring such that the control ring is capable of driving the gear ring due to limited movement of the joining pins along the long aperture.

9. The speed switching structure for an electric and pneumatic tool as claimed in claim 1, wherein the gear ring further comprises a ring slot for accepting the joining pins.

10. The speed switching structure for an electric and pneumatic tool as claimed in claim 1, wherein the gear ring further comprises a ring slot such that the control ring can be mounted in the ring slot; when the control ring engages with the gear ring in the first opening, the joining pins on the control ring protrude from the long apertures and enter into the containing channels of the sliding sleeve.
